(19) United States
(12) Patent Application Publication
(10) Pub. No.: US 2024/0232412 A1
(43) Pub. Date: Jul. 11, 2024

(54) INFORMATION PROCESSING APPARATUS, INFORMATION PROCESSING METHOD, AND COMPUTER READABLE RECORDING MEDIUM

(71) Applicant: NEC Corporation, Tokyo (JP)

(72) Inventor: Shunichi KINOSHITA, Tokyo (JP)

(73) Assignee: NEC Corporation, Tokyo (JP)

(21) Appl. No.: 18/399,035

(22) Filed: Dec. 28, 2023

(30) Foreign Application Priority Data
Jan. 11, 2023 (JP) 2023-002589

(51) Int. Cl. G06F 21/62

(52) U.S. Cl. CPC G06F 21/6218

(57) ABSTRACT

An information processing apparatus comprising: an access attribute identifying unit that identifies an access attribute for which different results are output from a first policy model and a second policy model when the access attribute is input to the first policy model and the second policy model that output, when an access attribute is input, results of determination regarding access having the input access attribute; and a divergence degree calculation unit that calculates a degree of divergence between a result of determination by the first policy model and a result of determination by the second policy model by comparing the results respectively output from the first policy model and the second policy model when the identified access attribute is input to the first policy model and the second policy model.

### CROSS-REFERENCE TO RELATED APPLICATION

This application is based upon and claims the benefit of priority from Japanese patent application No. 2023-002589, filed on Jan. 11, 2023, the disclosure of which is incorporated herein in its entirety by reference.

### BACKGROUND OF THE INVENTION

### 1. Field of the Invention

The present disclosure relates to an information processing apparatus and an information processing method for supporting management of security policies used in access control of a computer and further relates to a computer-readable recording medium having recorded thereon a program for realizing the information processing apparatus and the information processing method.

### 2. Background Art

In recent years, security policies have become important for organizations that operate large-scale computer systems, such as companies, to ensure the security of their computer systems. Security policies are guidelines set by an organization in order to maintain information security. Who is permitted to access the computer system, who is prohibited from accessing the computer system, and the like are determined in the computer system in accordance with the security policies.

Also, in an organization such as a company, operation policies that define operations are set for individual groups composing the organization according to systems of the respective groups, in addition to a baseline policy that defines guidelines of the overall organization. In this case, an administrator of the computer system needs to compare the baseline policy and each operation policy according to the state of the system and update the operation policies as necessary.

However, a large burden is placed on the administrator of the computer system to compare security policies and appropriately update the security policies. Also, updates need to be performed frequently: Therefore, Patent Documents 1 and 2 disclose systems for supporting management of security policies.

Specifically, Patent Document 1 discloses a system that analyzes equivalency of two security policies and issues a result that indicates whether or not the two security policies are equivalent. In Patent Document 1, the security policies are created by learned models such as neural networks. The security policies determine whether or not to permit access by a client, and output results.

Patent Document 2 discloses a system that estimates similarity between security policies. The system disclosed in Patent Document 2 counts differences between rules composing the security policies, and calculates the degree of similarity using the result of counting.
Patent Document 1: Japanese Patent Laid-Open Publication No. 2020-525898
Patent Document 2: Japanese Patent Laid-Open Publication No. 2007-072582

However, the system disclosed in Patent Document 1 merely outputs a result indicating whether or not the two security policies are equivalent, and there is a problem that the administrator cannot figure out the degree of divergence between the security policies. Therefore, it is difficult for the administrator to determine which part of the security policies needs to be updated.

On the other hand, the system disclosed in Patent Document 2 enables the administrator to figure out the degree of divergence between the security policies. However, the system disclosed in Patent Document 2 is devised on the premise that the security policies are composed of set rules. There is a problem that the system disclosed in Patent Document 2 cannot deal with security policies created by learned models.

### SUMMARY OF INVENTION

An example object of the present disclosure is to estimate the degree of divergence between a plurality of security policies created by learned models.

In order to achieve the above-described object, an information processing apparatus according to an example aspect of the invention includes:
an access attribute identifying unit that identifies an access attribute for which different results are output from a first policy model and a second policy model when the access attribute is input to the first policy model and the second policy model that output, when an access attribute is input, results of determination regarding access having the input access attribute; and
a divergence degree calculation unit that calculates a degree of divergence between a result of determination by the first policy model and a result of determination by the second policy model by comparing the results respectively output from the first policy model and the second policy model when the identified access attribute is input to the first policy model and the second policy model.

In addition, in order to achieve the above-described object, an information processing method according to an example aspect of the invention includes:
an access attribute identifying step of identifying an access attribute for which different results are output from a first policy model and a second policy model when the access attribute is input to the first policy model and the second policy model that output, when an access attribute is input, results of determination regarding access having the input access attribute: and
a divergence degree calculation step of calculating a degree of divergence between a result of determination by the first policy model and a result of determination by the second policy model by comparing the results respectively output from the first policy model and the second policy model when the identified access attribute is input to the first policy model and the second policy model.

Furthermore, in order to achieve the above-described object, a computer readable recording medium according to an example aspect of the invention is a computer readable recording medium that includes recorded thereon a program,
the program including instructions that cause the computer to carry out:
an access attribute identifying step of identifying an access attribute for which different results are output from a first policy model and a second policy model when the access attribute is input to the first policy model and the second policy model that output, when an access attribute is input, results of determination regarding access having the input access attribute: and
a divergence degree calculation step of calculating a degree of divergence between a result of determination by the first policy model and a result of determination by the second policy model by comparing the results respectively output from the first policy model and the second policy model when the identified access attribute is input to the first policy model and the second policy model.

As described above, according to the present disclosure, it is possible to estimate the degree of divergence between a plurality of security policies created by learned models.

### BRIEF DESCRIPTION OF THE DRAWINGS

FIG. 1 is a configuration diagram illustrating a schematic configuration of an example of an information processing apparatus.

FIG. 2 is a configuration diagram illustrating a specific configuration of the example of the information processing apparatus.

FIG. 3 is a configuration diagram illustrating a conceptual configuration of examples of first and second policy models.

FIG. 4 is a flowchart illustrating an example of operations of the information processing apparatus.

FIG. 5 is a configuration diagram illustrating a conceptual configuration of other examples of first and second policy models.

FIG. 6 is a configuration diagram illustrating a configuration of other example of the information processing apparatus.

FIG. 7 is a flowchart illustrating other example of operations of the information processing apparatus.

FIG. 8 is a configuration diagram illustrating a configuration of still another example of the information processing apparatus.

FIG. 9 is a flowchart illustrating still another example of operations of the information processing apparatus according to the third example embodiment.

FIG. 10 is a block diagram illustrating an example of a computer that realizes the information processing apparatus.

### EXAMPLE EMBODIMENT

### First Example Embodiment

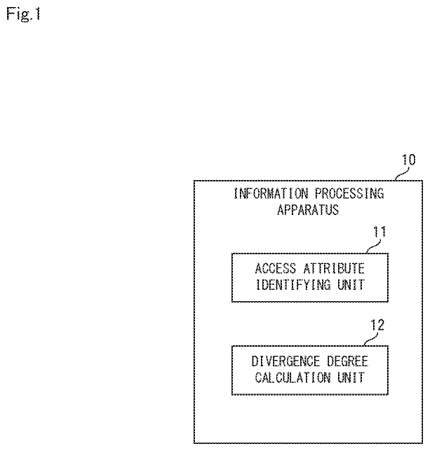

The following describes an information processing apparatus, an information processing method, and a program according to a first example embodiment with reference to FIGS. 1 to 5.

### [Apparatus Configuration]

First, a schematic configuration of the information processing apparatus according to the first example embodiment will be described with reference to FIG. 1. FIG. 1 is a configuration diagram illustrating a schematic configuration of an example of an information processing apparatus.

An information processing apparatus 10 illustrated in FIG. 1 is a security policy management support apparatus for supporting management of security policies used in access control of a computer. As illustrated in FIG. 1, the information processing apparatus 10 includes an access attribute identifying unit 11 and a divergence degree calculation unit 12.

The access attribute identifying unit 11 identifies an access attribute for which different results are output from a first policy model and a second policy model when the access attribute is input to the first policy model and the second policy model. The first policy model and the second policy model are models that output, when an access attribute is input, results of determination regarding access that has the input access attribute.

The divergence degree calculation unit 12 compares the results respectively output from the first policy model and the second policy model when the identified access attribute is input. The divergence degree calculation unit 12 calculates the degree of divergence between a result of determination by the first policy model and a result of determination by the second policy model through the comparison.

As described above, according to the first example embodiment, the degree of divergence between a plurality of security policies created by learned models is estimated. With use of the first example embodiment, an administrator can easily determine from where updating and the like of the security policies is to be initiated.

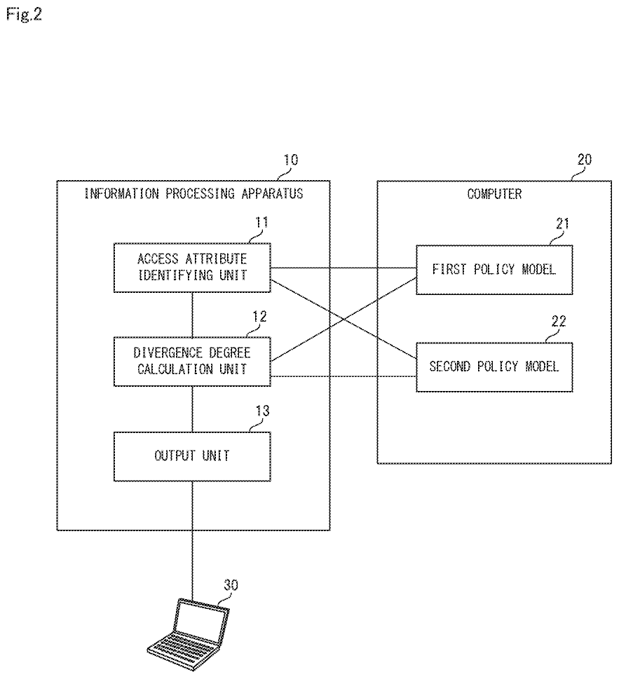

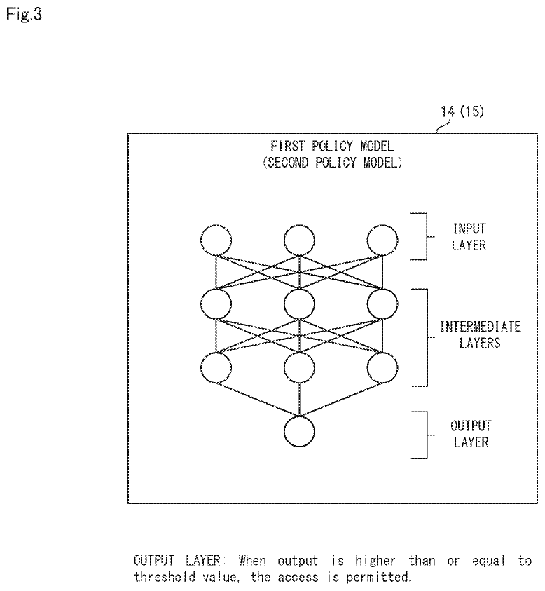

Next, the following specifically describes the configuration and functions of the information processing apparatus 10 with reference to FIGS. 2 and 3. FIG. 2 is a configuration diagram illustrating a specific configuration of the example of the information processing apparatus. FIG. 3 is a configuration diagram illustrating a conceptual configuration of examples of first and second policy models.

As illustrated in FIG. 2, the information processing apparatus 10 is connected to an external computer 20 via a network or the like in such a manner that data communication can be performed between the information processing apparatus and the external computer. The computer 20 implements a first policy model 21 and a second policy model 22. In the present embodiment, the first policy model 21 and the second policy model 22 are machine learning models that have learned a relationship between an access attribute and a determination regarding access that has the access attribute, through machine learning, and are implemented by machine learning programs executed by the computer 20. Note that either one or both of the first policy model 21 and the second policy model 22 may be implemented by the information processing apparatus 10.

Each of the first policy model 21 and the second policy model 22 is created by executing machine learning in which access attributes and determinations indicating permission or prohibition of access corresponding to the access attributes are used as training data. As illustrated in FIG. 3, each of the first policy model 21 and the second policy model 22 according to the first example embodiment is a neural network and includes an input layer, intermediate layers, and an output layer. Note that the structure of the neural network illustrated in FIG. 3 is merely an example, and the number of layers, the number of nodes included in each layer, and the like are not particularly limited. Also, combinations of nodes connected to each other may be selected appropriately.

As illustrated in FIG. 3, in the first example embodiment, when an access attribute is input to the input layer of the first policy model 21 (or the second policy model 22), a score is output from the output layer according to the input access attribute. When the score is higher than or equal to a threshold value, the first policy model 21 (or the second policy model 22) outputs access permission, otherwise, the first policy model 21 (or the second policy model 22) outputs prohibition of access. A configuration is also possible in which an access attribute is converted to a scalar or a vector and then input to the first policy model 21 (or the second policy model 22).

Specific examples of access attributes include the following (a) to (c) and combinations of these.
(a) A role (a department, a position, etc.) of the subject that is requesting access.
(b) A label (secret classification, applicability judgment, etc.) of the object that is to be accessed.
(c) A risk state, access history, threat information, or the like regarding the subject that is requesting access, the object that is to be accessed, and a communication path.

As described above, the access attribute identifying unit 11 identifies an access attribute for which different results are output from the first policy model 21 and the second policy model 22. For example, in the first example embodiment, the access attribute identifying unit 11 inputs the same access attribute prepared in advance to both the first policy model 21 and the second policy model 22. Then, when output from the first policy model and output from the second policy model differ from each other, the access attribute identifying unit 11 identifies the input access attribute as an access attribute for which different results are output from the policy models.

The access attribute identifying unit 11 may convert each of the first policy model 21 and the second policy model 22 to a propositional formula and solve satisfiability problems of the two converted propositional formulas to identify an access attribute for which different results are output from the policy models.

The access attribute identifying unit 11 may also create a plurality of access attributes at random and input each of the created access attributes to the first policy model 21 and the second policy model 22. In this case, when output from the first policy model and output from the second policy model obtained by inputting an access attribute differ from each other, the access attribute identifying unit 11 identifies the input access attribute as an access attribute for which different results are output from the policy models.

As described above, in the first example embodiment, the access attribute identifying unit 11 identifies an access attribute for which the first policy model 21 outputs access permission whereas the second policy model 22 outputs prohibition of access, for example. The access attribute identifying unit 11 can also identify an access attribute for which the first policy model 21 outputs prohibition of access whereas the second policy model 22 outputs access permission.

In the first example embodiment, the divergence degree calculation unit 12 calculates a difference between a score output from the output layer of the first policy model 21 and a score output from the output layer of the second policy model 22 when an access attribute identified by the access attribute identifying unit 11 is input. Then, the divergence degree calculation unit 12 takes the calculated difference as the degree of divergence between a result of determination by the first policy model 21 and a result of determination by the second policy model 22. Note that there is no particular limitation on the method for calculating the difference in the first example embodiment. The difference may be calculated through subtraction processing of the scores or a method of adopting the absolute value of the difference between the scores.

As illustrated in FIG. 2, the information processing apparatus 10 according to the first example embodiment includes an output unit 13 in addition to the access attribute identifying unit 11 and the divergence degree calculation unit 12 described above. The output unit 13 outputs the degree of divergence calculated by the divergence degree calculation unit 12 and the access attribute identified by the access attribute identifying unit 11. In the first example embodiment, the output unit 13 transmits the degree of divergence and the access attribute to a terminal device 30 of the administrator of security policies.

### [Apparatus Operations]

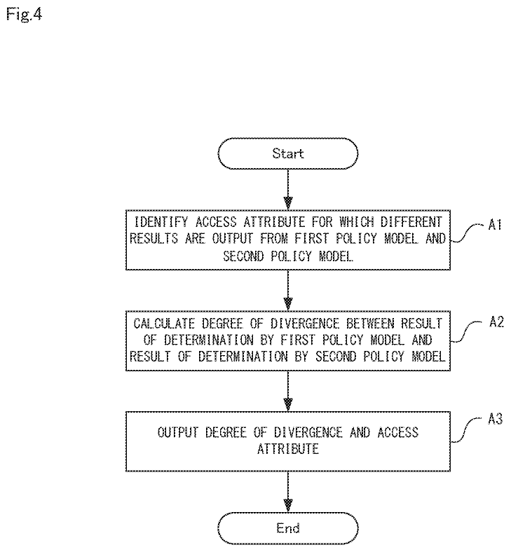

Next, operations of the information processing apparatus 10 will be described with reference to FIG. 4. FIG. 4 is a flowchart illustrating an example of operations of the information processing apparatus. The following description refers to FIGS. 1 to 3 as appropriate. In the first example embodiment, an information processing method is carried out by causing the information processing apparatus 10 to operate. Therefore, the following describes operations of the information processing apparatus 10 in place of the information processing method according to the first example embodiment.

As illustrated in FIG. 4, first, the access attribute identifying unit 11 identifies an access attribute for which different results are output from the first policy model 21 and the second policy model 22 when the access attribute is input to the first policy model and the second policy model (step A1).

Specifically, in step A1, the access attribute identifying unit 11 inputs the same access attribute prepared in advance to both the first policy model 21 and the second policy model 22. Then, when output from the first policy model and output from the second policy model differ from each other, the access attribute identifying unit 11 identifies the input access attribute as an access attribute for which different results are output from the policy models.

Next, the divergence degree calculation unit 12 compares the result output from the first policy model and the result output from the second policy model when the access attribute identified in step A1 is input, and calculates the degree of divergence between a result of determination by the first policy model 21 and a result of determination by the second policy model 22 from the comparison result (step A2).

Specifically, in step A2, the divergence degree calculation unit 12 calculates a difference between the compared results, and takes the calculated difference as the degree of divergence between a result of determination by the first policy model 21 and a result of determination by the second policy model 22.

Next, the output unit 13 outputs the degree of divergence calculated in step A2 and the access attribute identified in step A1 (step A3). Specifically; in step A3, the output unit 13 transmits the degree of divergence and the access attribute to the terminal device 30 of the administrator of security policies.

As described above, when steps A1 to A3 are executed, the degree of divergence between the first policy model 21 and the second policy model 22 is estimated, and presented to the administrator. Therefore, according to the first example embodiment, the administrator can set an appropriate priority level for updates of the security policies, and easily determine from where updating and the like of the security policies is to be initiated.

### [Program]

A program according to the first example embodiment is only required to be a program that causes a computer to execute steps A1 to A3 illustrated in FIG. 4. The information processing apparatus 10 and the information processing method according to the first example embodiment can be realized by installing the program in a computer and executing the program. In this case, a processor of the computer performs processing by functioning as the access attribute identifying unit 11, the divergence degree calculation unit 12, and the output unit 13. Examples of the computer include a smartphone and a tablet terminal device, as well as a general-purpose PC.

The program according to the first example embodiment may also be executed by a computer system composed of a plurality of computers. In this case, each computer may function as any of the access attribute identifying unit 11, the divergence degree calculation unit 12, and the output unit 13, for example.

### [Variation]

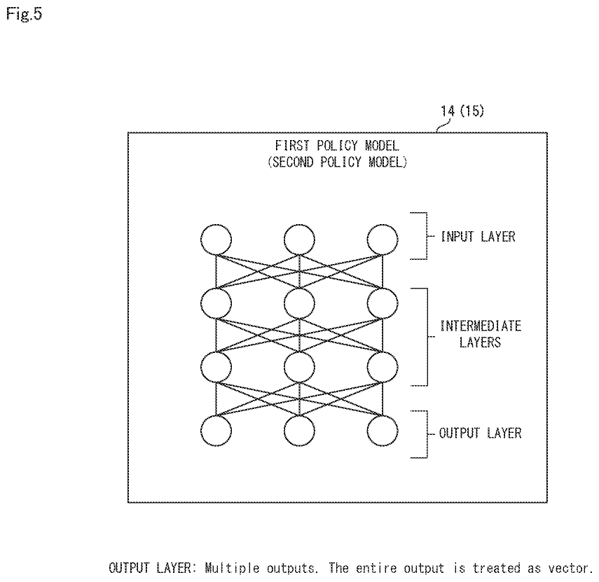

Here, a variation of the information processing apparatus 10 according to the first example embodiment will be described. FIG. 5 is a configuration diagram illustrating a conceptual configuration of other examples of first and second policy models.

In this variation, the first policy model 21 and the second policy model 22 are machine learning models that have learned a relationship between an access attribute and an action corresponding to the access attribute, through machine learning. In this variation, each of the first policy model 21 and the second policy model 22 is created by executing machine learning in which access attributes and actions corresponding to the access attributes are used as training data.

Examples of the actions include “requesting multi-factor authentication” and “outputting an alert”, in addition to “permitting access” and “prohibiting access” described above.

As illustrated in FIG. 5, in this variation, the output layer of the first policy model 21 (or the second policy model 22) includes a plurality of nodes corresponding to the number of actions. Accordingly, when an access attribute is input to the input layer of the first policy model 21 (or the second policy model 22), a score is output from each node in the output layer according to the input access attribute. Then, the first policy model 21 (or the second policy model 22) identifies a node from which the highest score is output, and outputs an action corresponding to the identified node.

Therefore, in this variation, the divergence degree calculation unit 12 obtains scores output from the respective nodes in the output layer of each of the first policy model 21 and the second policy model 22, and treats the scores as vectors. Then, the divergence degree calculation unit 12 takes a difference between the vector obtained from the output layer of the first policy model 21 and the vector obtained from the output layer of the second policy model 22 as the degree of divergence between a result of determination by the first policy model 21 and a result of determination by the second policy model 22.

Specific examples of the difference between the vectors include a cross-entropy of a Softmax function, cosine similarity whose sign is inverted, and Euclidean distance. The divergence degree calculation unit 12 can calculate the difference between the vectors with use of these calculation methods. As described above, according to this variation, it is also possible to support policy models in which the output layer includes a plurality of nodes.

### Second Example Embodiment

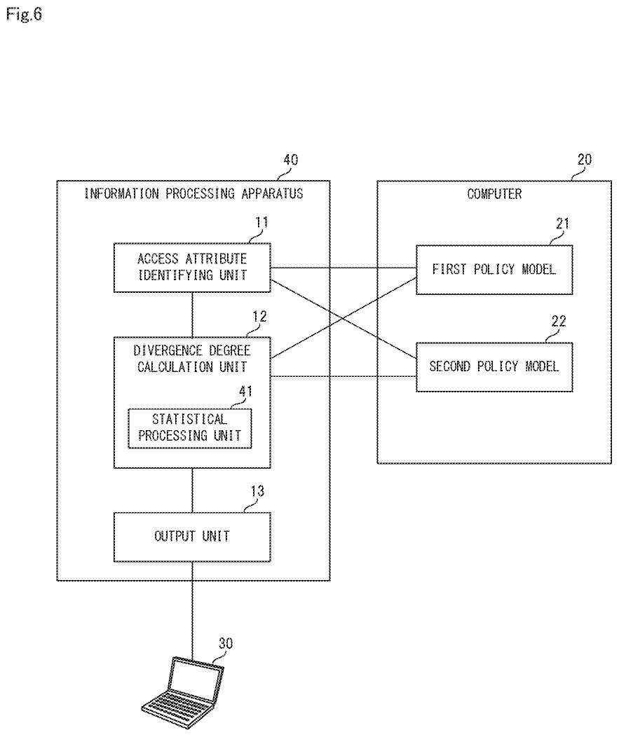

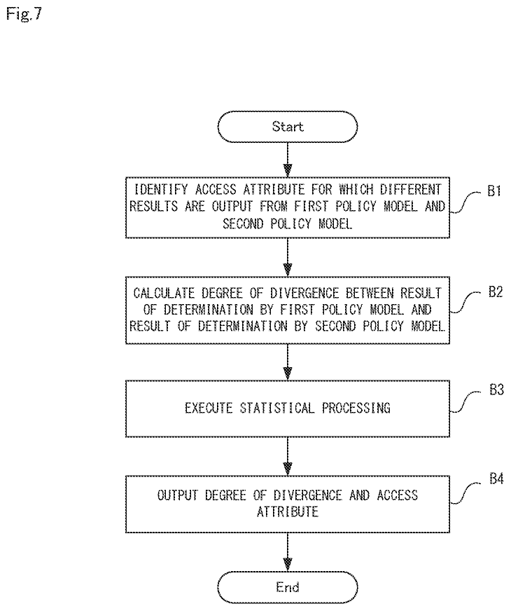

Next, the following describes an information processing apparatus, an information processing method, and a program according to a second example embodiment with reference to FIGS. 6 and 7.

### [Apparatus Configuration]

A configuration of the information processing apparatus according to the second example embodiment will be described with reference to FIG. 6. FIG. 6 is a configuration diagram illustrating a configuration of other example of the information processing apparatus.

As in the first example embodiment, an information processing apparatus 40 illustrated in FIG. 6 is also a security policy management support apparatus for supporting management of security policies used in access control of a computer.

However, unlike the information processing apparatus 10 illustrated in FIG. 2, the divergence degree calculation unit 12 of the information processing apparatus 40 includes a statistical processing unit 41 as illustrated in FIG. 6. The following describes differences from the first example embodiment.

First, in the second example embodiment, the access attribute identifying unit 11 identifies access attributes for each of which different results are output from the first policy model and the second policy model. Then, the divergence degree calculation unit 12 calculates the degree of divergence with respect to each access attribute that is identified. Note that the number of identified access attributes may be one or two or more.

Then, the statistical processing unit 41 in the divergence degree calculation unit 12 executes statistical processing using all calculated degrees of divergence, and takes the result of the statistical processing as the final degree of divergence. Specific examples of the statistical processing include processing for totaling the degrees of divergence, processing for averaging the degrees of divergence, and processing for selecting the highest degree of divergence.

### [Apparatus Operations]

Next, operations of the information processing apparatus 40 will be described with reference to FIG. 7. FIG. 7 is a flowchart illustrating other example of operations of the information processing apparatus. The following description refers to FIG. 6 as appropriate. In the second example embodiment, an information processing method is carried out by causing the information processing apparatus 40 to operate. Therefore, the following describes operations of the information processing apparatus 40 in place of the information processing method according to the second example embodiment.

As illustrated in FIG. 7, first, the access attribute identifying unit 11 identifies a plurality of access attributes for each of which different results are output from the first policy model 21 and the second policy model 22 when the access attribute is input to the first policy model and the second policy model (step B1).

Step B1 is similar to step A1 illustrated in FIG. 4. However, processing similar to that performed in step A1 is performed a plurality of times in step B1 until a plurality of access attributes are identified.

Next, the divergence degree calculation unit 12 calculates the degree of divergence between a result of determination by the first policy model 21 and a result of determination by the second policy model 22 with respect to each of the plurality of access attributes identified in step B1 (step B2).

Step B2 is similar to step A2 illustrated in FIG. 4. However, processing similar to that performed in step A2 is performed with respect to each of the plurality access attributes in step B2.

Next, the statistical processing unit 41 in the divergence degree calculation unit 12 executes statistical processing using all the degrees of divergence calculated in step B2, and takes the result of the statistical processing as the final degree of divergence (step B3).

Next, the output unit 13 outputs the result of the statistical processing (the degree of divergence) calculated in step B3 and the access attributes identified in step B1 (step B4). Specifically, in step B4, the output unit 13 transmits the result of the statistical processing and the access attributes to the terminal device 30 of the administrator of security policies.

As described above, when steps B1 to B4 are executed, the degree of divergence between the first policy model 21 and the second policy model 22 is estimated, and presented to the administrator. Therefore, according to the second example embodiment as well, the administrator can set an appropriate priority level for updates of the security policies, and easily determine from where updating and the like of the security policies is to be initiated. Also, in the second example embodiment, the determination can be made based on a plurality of access attributes, and therefore, it is easy to identify a security policy that definitely needs to be updated.

### [Program]

A program according to the second example embodiment is only required to be a program that causes a computer to execute steps B1 to B4 illustrated in FIG. 7. The information processing apparatus 40 and the information processing method according to the second example embodiment can be realized by installing the program in a computer and executing the program. In this case, a processor of the computer performs processing by functioning as the access attribute identifying unit 11, the divergence degree calculation unit 12, and the output unit 13. Examples of the computer include a smartphone and a tablet terminal device, as well as a general-purpose PC.

The program according to the second example embodiment may also be executed by a computer system composed of a plurality of computers. In this case, each computer may function as any of the access attribute identifying unit 11, the divergence degree calculation unit 12, and the output unit 13, for example.

### Third Example Embodiment

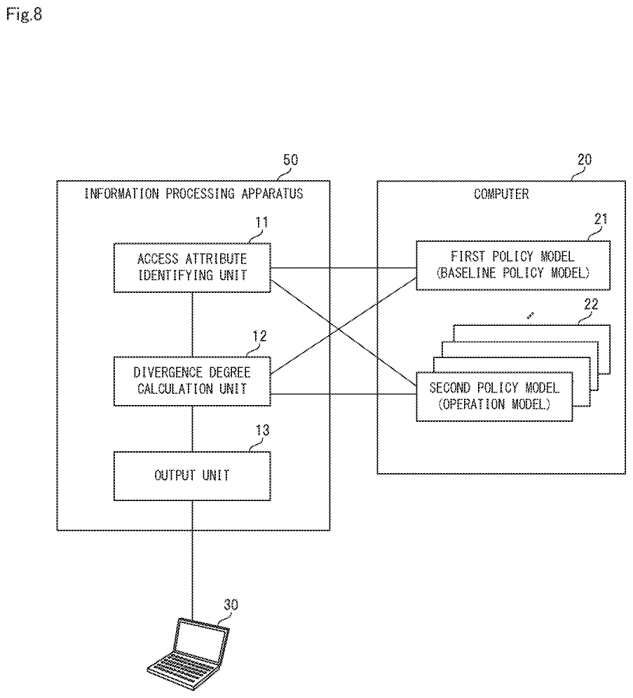

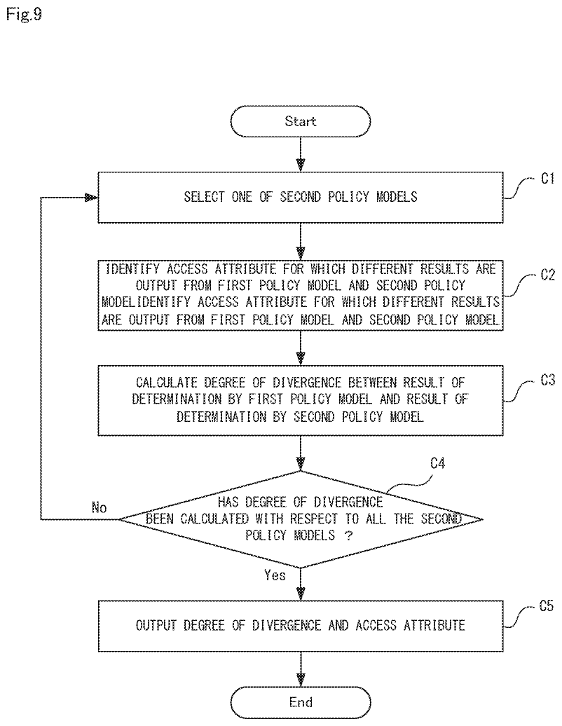

Next, the following describes an information processing apparatus, an information processing method, and a program according to a third example embodiment with reference to FIGS. 8 and 9.

### [Apparatus Configuration]

A configuration of the information processing apparatus according to the third example embodiment will be described with reference to FIG. 8. FIG. 8 is a configuration diagram illustrating a configuration of still another example of the information processing apparatus.

As in the first and second example embodiments, an information processing apparatus 50 illustrated in FIG. 8 is also a security policy management support apparatus for supporting management of security policies used in access control of a computer.

However, unlike the information processing apparatus 10 according illustrated in FIG. 2 and the information processing apparatus 40 illustrated in FIG. 6, the information processing apparatus 50 supports a plurality of second policy models 22 as illustrated in FIG. 8. The following describes differences from the first and second example embodiments.

As illustrated in FIG. 8, in the third example embodiment, there is a first policy model 21 and a plurality of second policy models 22. In this case, the access attribute identifying unit 11 identifies, with respect to each of the second policy models 22, an access attribute for which different results are output from the first policy model 21 and the second policy model 22.

Also, in the third example embodiment, the divergence degree calculation unit 12 calculates, with respect to each of the second policy models 22, the degree of divergence between a result of determination by the first policy model 21 and a result of determination by the second policy model 22.

In the third example embodiment, the first policy model 21 is a model (hereinafter referred to as a “baseline policy model”) that defines a security policy applied to the entire computer system of the organization. The second policy models 22 are models (hereinafter referred to as “operation models”) that define security policies of respective groups composing the organization.

### [Apparatus Operations]

Next, operations of the information processing apparatus 50 will be described with reference to FIG. 9. FIG. 9 is a flowchart illustrating still another example of operations of the information processing apparatus according to the third example embodiment. The following description refers to FIG. 8 as appropriate. In the third example embodiment, an information processing method is carried out by causing the information processing apparatus 50 to operate. Therefore, the following describes operations of the information processing apparatus 50 in place of the information processing method according to the third example embodiment.

As illustrated in FIG. 9, first, the access attribute identifying unit 11 selects one of the second policy models (step C1).

Next, the access attribute identifying unit 11 identifies an access attribute for which different results are output from the first policy model 21 and the second policy model 22 selected in step C1 when the access attribute is input to the first policy model and the second policy model (step C2). Step C2 is similar to step A1 illustrated in FIG. 4.

Next, the divergence degree calculation unit 12 compares the result output from the first policy model and the result output from the second policy model selected in step C1 when the access attribute identified in step C2 is input, and calculates the degree of divergence between a result of determination by the first policy model 21 and a result of determination by the second policy model 22 from the result of comparison (step C3). Step C3 is similar to step A2 illustrated in FIG. 4.

Next, the divergence degree calculation unit 12 determines whether or not the degree of divergence has been calculated with respect to all the second policy models (step C4). When it is determined in step C4 that the degree of divergence has not been calculated with respect to all of the second policy models, step C1 is executed again.

On the other hand, when it is determined in step C4 that the degree of divergence has been calculated with respect to all of the second policy models, the output unit 13 outputs, with respect to each second policy model 22, the degree of divergence calculated in step C3 and the access attribute identified in step C2 (step C5). Specifically, in step C5, the output unit 13 transmits, with respect to each second policy model 22, the degree of divergence and access attribute to the terminal device 30 of the administrator of security policies.

As described above, when steps C1 to C5 are executed, the degree of divergence between the first policy model 21 and each second policy model 22 is estimated, and presented to the administrator. Therefore, according to the third example embodiment, the administrator can set an appropriate priority level for updates of the security policies with respect to each group composing the organization, and easily determine from where updating and the like of the security policies is to be initiated.

### [Program]

A program according to the third example embodiment is only required to be a program that causes a computer to execute steps C1 to C5 illustrated in FIG. 9. The information processing apparatus 50 and the information processing method according to the third example embodiment can be realized by installing the program in a computer and executing the program. In this case, a processor of the computer performs processing by functioning as the access attribute identifying unit 11, the divergence degree calculation unit 12, and the output unit 13. Examples of the computer include a smartphone and a tablet terminal device, as well as a general-purpose PC.

The program according to the third example embodiment may also be executed by a computer system composed of a plurality of computers. In this case, each computer may function as any of the access attribute identifying unit 11, the divergence degree calculation unit 12, and the output unit 13, for example.

### [Physical Configuration]

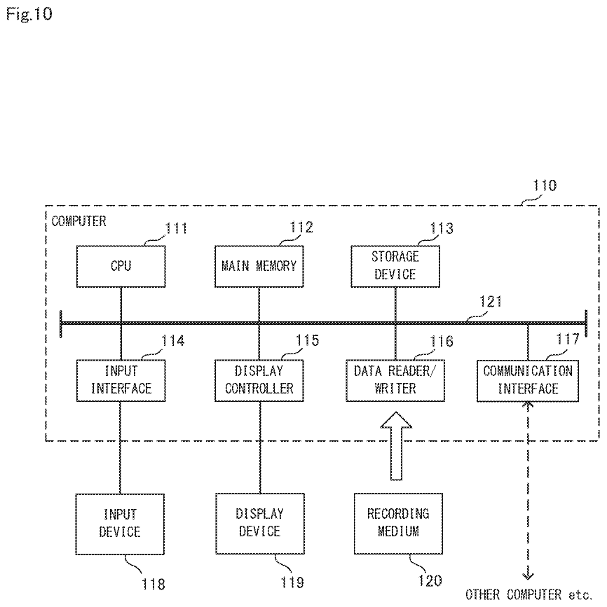

Using FIG. 10, the following describes a computer that realizes the information processing apparatus by executing the program according to the first to third example embodiment. FIG. 10 is a block diagram illustrating an example of a computer that realizes the information processing apparatus.

As shown in FIG. 10, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121.

The computer 110 may include a GPU (Graphics Processing Unit) or an FPGA (Field-Programmable Gate Array) in addition to the CPU 111, or in place of the CPU 111. In this case, the GPU or the FPGA can execute the program according to the example embodiment.

The CPU 111 deploys the program according to the example embodiment, which is composed of a code group stored in the storage device 113 to the main memory 112, and carries out various types of calculation by executing the codes in a predetermined order. The main memory 112 is typically a volatile storage device, such as a DRAM (dynamic random-access memory).

Also, the program according to the example embodiment is provided in a state where it is stored in a computer-readable recording medium 120. Note that the program according to the example embodiment may be distributed over the Internet connected via the communication interface 117.

Also, specific examples of the storage device 113 include a hard disk drive and a semiconductor storage device, such as a flash memory. The input interface 114 mediates data transmission between the CPU 111 and an input device 118, such as a keyboard and a mouse. The display controller 115 is connected to a display device 119, and controls display on the display device 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Specific examples of the recording medium 120 include: a general-purpose semiconductor storage device, such as CF (CompactFlash®) and SD (Secure Digital): a magnetic recording medium, such as a flexible disk: and an optical recording medium, such as a CD-ROM (Compact Disk Read Only Memory).

Note that the information processing apparatus according to the example embodiment can also be realized by using items of hardware, for example, electric circuit that respectively correspond to the components rather than the computer in which the program is installed. Furthermore, a part of the information processing apparatus may be realized by the program, and the remaining part of the information processing apparatus may be realized by hardware. In the example embodiment, the computer is not limited to the computer illustrated in FIG. 10.

A part or an entirety of the above-described example embodiment can be represented by (Supplementary Note 1) to (Supplementary Note 18) described below but is not limited to the description below:

### (Supplementary Note 1)

An information processing apparatus comprising:
an access attribute identifying unit that identifies an access attribute for which different results are output from a first policy model and a second policy model when the access attribute is input to the first policy model and the second policy model that output, when an access attribute is input, results of determination regarding access having the input access attribute; and
a divergence degree calculation unit that calculates a degree of divergence between a result of determination by the first policy model and a result of determination by the second policy model by comparing the results respectively output from the first policy model and the second policy model when the identified access attribute is input to the first policy model and the second policy model.

### (Supplementary Note 2)

The information processing apparatus according to Supplementary Note 1,
wherein the access attribute identifying unit identifies a plurality of the access attributes, and
the divergence degree calculation unit calculates the degree of divergence with respect to each of the plurality of access attributes, and executes statistical processing using all of the calculated degrees of divergence.

### (Supplementary Note 3)

The information processing apparatus according to Supplementary Note 1,
wherein, in a case where there is the first policy model and a plurality of the second policy models,
the access attribute identifying unit identifies the access attribute with respect to each of the plurality of second policy models, and
the divergence degree calculation unit calculates the degree of divergence with respect to each of the plurality of second policy models.

### (Supplementary Note 4)

The information processing apparatus according to Supplementary Note 3,
wherein the first policy model is a model that defines a security policy applied to an entire computer system of an organization, and
the second policy models are models that define security policies of respective groups composing the organization.

### (Supplementary Note 5)

The information processing apparatus according to Supplementary Note 1, further comprising:
an output unit that outputs the degree of divergence calculated by the divergence degree calculation unit and the access attribute identified by the access attribute identifying unit.

### (Supplementary Note 6)

The information processing apparatus according to Supplementary Note 1,
wherein the first policy model and the second policy model are machine learning models that have learned a relationship between an access attribute and a determination regarding access that has the access attribute, through machine learning.

### (Supplementary Note 7)

An information processing method comprising:
an access attribute identifying step of identifying an access attribute for which different results are output from a first policy model and a second policy model when the access attribute is input to the first policy model and the second policy model that output, when an access attribute is input, results of determination regarding access having the input access attribute; and
a divergence degree calculation step of calculating a degree of divergence between a result of determination by the first policy model and a result of determination by the second policy model by comparing the results respectively output from the first policy model and the second policy model when the identified access attribute is input to the first policy model and the second policy model.

### (Supplementary Note 8)

The information processing method according to Supplementary Note 7,
wherein, in the access attribute identifying step, a plurality of the access attributes are identified, and
in the divergence degree calculation step, the degree of divergence is calculated with respect to each of the plurality of access attributes, and statistical processing is executed using all of the calculated degrees of divergence.

### (Supplementary Note 9)

The information processing method according to Supplementary Note 7,
wherein, in a case where there is the first policy model and a plurality of the second policy models,
in the access attribute identifying step, the access attribute is identified with respect to each of the plurality of second policy models, and
in the divergence degree calculation step, the degree of divergence is calculated with respect to each of the plurality of second policy models.

### (Supplementary Note 10)

The information processing method according to Supplementary Note 9,
wherein the first policy model is a model that defines a security policy applied to an entire computer system of an organization, and
the second policy models are models that define security policies of respective groups composing the organization.

### (Supplementary Note 11)

The information processing method according to Supplementary Note 7, further comprising:
an output step of outputting the degree of divergence calculated in the divergence degree calculation step and the access attribute identified in the access attribute identifying step.

### (Supplementary Note 12)

The information processing method according to Supplementary Note 7,
wherein the first policy model and the second policy model are machine learning models that have learned a relationship between an access attribute and a determination regarding access that has the access attribute, through machine learning.

### (Supplementary Note 13)

A computer readable recording medium that includes a program recorded thereon, the program including instructions that cause a computer to carry out:
an access attribute identifying step of identifying an access attribute for which different results are output from a first policy model and a second policy model when the access attribute is input to the first policy model and the second policy model that output, when an access attribute is input, results of determination regarding access having the input access attribute: and
a divergence degree calculation step of calculating a degree of divergence between a result of determination by the first policy model and a result of determination by the second policy model by comparing the results respectively output from the first policy model and the second policy model when the identified access attribute is input to the first policy model and the second policy model.

### (Supplementary Note 14)

The computer readable recording medium according to Supplementary Note 13,
wherein, in the access attribute identifying step, a plurality of the access attributes are identified, and
in the divergence degree calculation step, the degree of divergence is calculated with respect to each of the plurality of access attributes, and statistical processing is executed using all of the calculated degrees of divergence.

### (Supplementary Note 15)

The computer readable recording medium according to Supplementary Note 13,
wherein, in a case where there is the first policy model and a plurality of the second policy models,
in the access attribute identifying step, the access attribute is identified with respect to each of the plurality of second policy models, and
in the divergence degree calculation step, the degree of divergence is calculated with respect to each of the plurality of second policy models.

### (Supplementary Note 16)

The computer readable recording medium according to Supplementary Note 15,
wherein the first policy model is a model that defines a security policy applied to an entire computer system of an organization, and
the second policy models are models that define security policies of respective groups composing the organization.

### (Supplementary Note 17)

The computer readable recording medium according to Supplementary Note 13,
wherein the program further includes instructions that cause the computer to carry out an output step of outputting the degree of divergence calculated in the divergence degree calculation step and the access attribute identified in the access attribute identifying step.

### (Supplementary Note 18)

The computer readable recording medium according to Supplementary Note 13,
wherein the first policy model and the second policy model are machine learning models that have learned a relationship between an access attribute and a determination regarding access that has the access attribute, through machine learning.

### INDUSTRIAL APPLICABILITY

As described above, according to the present disclosure, it is possible to estimate the degree of divergence between a plurality of security policies created by learned models. The present disclosure is useful for a system that requires management of a security policy.

### REFERENCE SIGNS LIST

10 Information processing apparatus
11 Access attribute identifying unit
12 Divergence degree calculation unit
13 Output unit
20 Computer
21 First policy model
22 Second policy model
30 Terminal device of the administrator
40 Information processing apparatus
41 Statistical processing unit
50 Information processing apparatus
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. An information processing apparatus comprising:
at least one memory storing instructions; and
at least one processor configured to execute the instructions to:
identify an access attribute for which different results are output from a first policy model and a second policy model when the access attribute is input to the first policy model and the second policy model that output, when an access attribute is input, results of determination regarding access having the input access attribute; and
calculate a degree of divergence between a result of determination by the first policy model and a result of determination by the second policy model by comparing the results respectively output from the first policy model and the second policy model when the identified access attribute is input to the first policy model and the second policy model.

2. The information processing apparatus according to claim 1,
further at least one processor configured to execute the instructions to:
identify a plurality of the access attributes, and
calculate the degree of divergence with respect to each of the plurality of access attributes, and execute statistical processing using all of the calculated degrees of divergence.

3. The information processing apparatus according to claim 1,
wherein, in a case where there is the first policy model and a plurality of the second policy models,
further at least one processor configured to execute the instructions to:
identify the access attribute with respect to each of the plurality of second policy models, and
calculate the degree of divergence with respect to each of the plurality of second policy models.

4. The information processing apparatus according to claim 3,
wherein the first policy model is a model that defines a security policy applied to an entire computer system of an organization, and
the second policy models are models that define security policies of respective groups composing the organization.

5. The information processing apparatus according to claim 1,
further at least one processor configured to execute the instructions to:
output the degree of divergence calculated by the divergence degree calculation unit and the access attribute identified by the access attribute identifying unit.

6. The information processing apparatus according to claim 1,
wherein the first policy model and the second policy model are machine learning models that have learned a relationship between an access attribute and a determination regarding access that has the access attribute, through machine learning.

7. An information processing method comprising:
identifying an access attribute for which different results are output from a first policy model and a second policy model when the access attribute is input to the first policy model and the second policy model that output, when an access attribute is input, results of determination regarding access having the input access attribute; and
calculating a degree of divergence between a result of determination by the first policy model and a result of determination by the second policy model by comparing the results respectively output from the first policy model and the second policy model when the identified access attribute is input to the first policy model and the second policy model.

8. The information processing method according to claim 7,
wherein, in the identifying the access attribute, a plurality of the access attributes are identified, and
in the calculating the divergence degree, the degree of divergence is calculated with respect to each of the plurality of access attributes, and statistical processing is executed using all of the calculated degrees of divergence.

9. The information processing method according to claim 7,
wherein, in a case where there is the first policy model and a plurality of the second policy models,
in the identifying the access attribute, the access attribute is identified with respect to each of the plurality of second policy models, and
in the calculating the divergence degree, the degree of divergence is calculated with respect to each of the plurality of second policy models.

10. The information processing method according to claim 9,
wherein the first policy model is a model that defines a security policy applied to an entire computer system of an organization, and
the second policy models are models that define security policies of respective groups composing the organization.

11. The information processing method according to claim 7, further comprising:
outputting the degree of divergence calculated in the divergence degree calculation step and the access attribute identified in the access attribute identifying step.

12. The information processing method according to claim 7,
wherein the first policy model and the second policy model are machine learning models that have learned a relationship between an access attribute and a determination regarding access that has the access attribute, through machine learning.

13. A non-transitory computer readable recording medium that includes a program recorded thereon, the program including instructions that cause a computer to carry out:
an access attribute identifying step of identifying an access attribute for which different results are output from a first policy model and a second policy model when the access attribute is input to the first policy model and the second policy model that output, when an access attribute is input, results of determination regarding access having the input access attribute; and
a divergence degree calculation step of calculating a degree of divergence between a result of determination by the first policy model and a result of determination by the second policy model by comparing the results respectively output from the first policy model and the second policy model when the identified access attribute is input to the first policy model and the second policy model.

14. The non-transitory computer readable recording medium according to claim 13,
wherein, in the identifying the access attribute, a plurality of the access attributes are identified, and
in the calculating the divergence degree, the degree of divergence is calculated with respect to each of the plurality of access attributes, and statistical processing is executed using all of the calculated degrees of divergence.

15. The non-transitory computer readable recording medium according to claim 13,
wherein, in a case where there is the first policy model and a plurality of the second policy models,
in the identifying the access attribute, the access attribute is identified with respect to each of the plurality of second policy models, and
in the calculating the divergence degree, the degree of divergence is calculated with respect to each of the plurality of second policy models.

16. The non-transitory computer readable recording medium according to claim 15,
wherein the first policy model is a model that defines a security policy applied to an entire computer system of an organization, and
the second policy models are models that define security policies of respective groups composing the organization.

17. The non-transitory computer readable recording medium according to claim 13,
wherein the program further includes instructions that cause the computer to carry out;
outputting the degree of divergence calculated in the divergence degree calculation step and the access attribute identified in the access attribute identifying step.

18. The non-transitory computer readable recording medium according to claim 13,
wherein the first policy model and the second policy model are machine learning models that have learned a relationship between an access attribute and a determination regarding access that has the access attribute, through machine learning.
